(19) United States
(12) Patent Application Publication
(10) Pub. No.: US 2025/0347062 A1
(43) Pub. Date: Nov. 13, 2025

(54) ASPHALT IMPRINTING SYSTEMS, METHODS AND APPARATUSES FOR CREATING A MUSICAL ROAD

(71) Applicant: SANBAR CONSTRUCTION CORP., Albuquerque, NM (US)

(72) Inventors: Robert Joseph Silva, Tijeras, NM (US); Frank A. Sanchez, Corrales, NM (US)

(73) Assignee: SANBAR CONSTRUCTION CORP., Albuquerque, NM (US)

(21) Appl. No.: 18/661,101

(22) Filed: May 10, 2024

(51) Int. Cl. E01C 19/43; B44B 5/00; B44B 5/02

(52) U.S. Cl. CPC E01C 19/43; B44B 5/0009; B44B 5/02

(57) ABSTRACT

Systems, methods, and apparatuses for imprinting a predefined pattern in a freshly rolled or heated asphalt surface of a traffic lane to create varying frequencies that produces musical notes are descried. A ridged steel, grid-like template can be progressively compressed into a roadway's heated and pliable asphalt surface using a drum roller or other surface compactor. The template is then manually lifted clear of the asphalt surface and the asphalt is allowed to cool to its natural hardened state. What results is a linear pattern of divots imprinted into about one-third width of either the right or left side of the traffic lane. The patterned asphalt surface can be treated with a thin coating of colored coating or legends and symbols to enhance the location of the musical notes on the roadway.

### FIELD OF THE INVENTION

This application relates to a method and apparatus for imprinting a pre-defined pattern in a freshly rolled or preheated asphalt surface. More particularly, this invention relates to a method for impressing a ridged or semi-ridged steel, grid-like template into a hot bitumastic surfaces from here on referred to as hot asphalt surface to produce frequencies which produce musical notes that comprise a musical road.

### BACKGROUND OF THE INVENTION

In constructing roadways there are typically two types of materials used; namely, asphalt, or concrete. For this purpose, only hot asphalt surfaces will be discussed.

Various methods and apparatuses for imprinting surface patterns in cementitious materials, such as concrete, are known in the prior art. For example, U.S. Pat. Nos. 3,832,079 and 3,910,711 which issued to Moorhead on Aug. 27, 1974, and Oct. 7, 1975, respectively, relate to a method and apparatus for imprinting a pattern into uncured concrete. The Moorhead process involves the use of an axle mounted pattern roller having blades which are impressed into the uncured concrete to simulate the appearance of blocks, bricks, cobblestones and the like. A plastic film is positioned between the roller blades and the concrete surface to act as a release agent and to prevent binding or gouging of the concrete.

U.S. Pat. No. 4,105,354, which issued to Bowman on Aug. 8, 1978, describes a wheel-like forming tool for imprinting surface patterns in a slab of freshly cast, plastic concrete. The concrete-penetrating blades are mounted on the exterior of the wheel frame in a grid like fashion. A series of pattern forming wheels can be interconnected together to imprint large slabs of concrete, thus overcoming the disadvantages of fixed-width rollers, such as the Moorhead apparatus referred to above.

Such prior art concrete pattern forming methods and apparatuses are not specifically adapted for imprinting hot bitumastic surfaces, such as asphalt. For example, some plastic or rubber-based concrete pattern formers cannot withstand the high temperature of freshly rolled or heated asphalt, which can typically be on the order of 275-300 degrees. Similarly, some release agents for preventing adherence between the pattern former and the concrete surface are not suitable for use with hot, petroleum-based asphalt. Further, several of the prior art concrete forming tools are substantially rigid and would tend to bend or deform when impacted into the asphalt surface with a high degree of pressure, such as by using a double drum roller or a plate compactor.

In U.S. Pat. No. 5,215,402, which issued to Stowell et al on Jun. 1, 1993, describes a method and apparatus for imprinting a predefined pattern in a freshly rolled asphalt surface to simulate the appearance of bricks, cobblestones, interlocking paving stones or the like. A pliable, grid-like template is progressively compressed into the asphalt surface using a drum roller or other surface compactor. The template is then manually lifted clear of the asphalt surface and the asphalt is allowed to harden.

Although prior methods are directed to obtaining a visual effect by imprinting surfaces, details for systems, methods and apparatuses that can be utilized to achieve varying acoustic effects are not currently described. Accordingly, the need has arisen for a systems, methods and apparatuses that can be used for imprinting freshly rolled or reheated asphalt surfaces to imprint musical notes therein to create acoustical effects resulting in an audible melody that is emitted as vehicle tires roll over the imprinted asphalt resulting in a musical roadway.

### SUMMARY OF THE INVENTION

Systems, methods, and apparatuses for imprinting a predefined pattern in a freshly rolled or heated asphalt surface to create a frequency that produces a musical note are described.

In accordance with the embodiments, ridged steel, grid-like musical note templates representing various acoustic sounds can be selectively and progressively compressed linearly along a side of a lane of a roadway, one after another, into a heated and pliable asphalt surface using a compaction apparatus. Once compacted into the asphalt to create its impression in the form of a series of grooves, each template is lifted clear of the asphalt surface and the asphalt is allowed to cool to its natural hardened state. The groove patterned asphalt surface can then be treated with a thin coating of colored coating or legends and symbols to enhance driver recognition of the location of the musical notes along a roadway.

In accordance with an embodiment, a method for imprinting an asphalt surface is disclosed that includes the steps of preheating a strip of asphalt surface along a side of a lane along a roadway using a rolling heating apparatus until the asphalt is heated and pliable; selectively and progressively compressing ridged steel, grid-like musical note templates representing various acoustic sounds of a melody linearly along the roadway, one after another, into the heated and pliable asphalt surface using a compaction apparatus; removing the ridged steel, grid-like musical note templates from the roadway after their compaction into the roadway by compaction apparatus and allowing the roadway to cool; and repeating steps of preheating asphalt along the roadway, compressing template into the roadway, removing templates, and allowing the roadway to cool until a desired melody is impressed linearly into the chosen side of the lane of the roadway.

In accordance with another embodiment, a method for imprinting an asphalt surface is disclosed which includes the steps of: (a) positioning a plurality of metal musical note templates comprising a plurality of musical notes in a selected and pre-defined pattern, one after the other, and impressing the templates into a heated asphalt surface; (c) compressing the musical note templates into the asphalt surface using a compaction apparatus moving along a backside of the musical note templates to leave an impression of the predefined pattern of grooves on the asphalt surface; (d) removing the compaction apparatus from the backside of the note template; (e) lifting the note template clear of the asphalt surface; and (f) repeating steps (a) through (e) until a selection of the musical note templates needed to create certain music selected for imprinting on the asphalt surface have been imprinted into the roadway, wherein grooved impressions formed in the asphalt create varying acoustic sounds representing notes as vehicle tires roll over the grooved impressions when travelling along the roadway.

In accordance with another embodiment, a method for imprinting an asphalt surface is disclosed which includes the steps of: (a) heating an asphalt surface along a portion of a roadway selected for bearing a musical note template using a multiple heating element, rolling asphalt heater, (b) positioning a plurality of metal musical note templates comprising a plurality of musical notes in a selected and pre-defined pattern, one after the other, (c) compressing the musical note templates into the asphalt surface using a rolling compaction apparatus rolling along a backside of the musical note templates to leave an impression of the predefined pattern of grooves on the asphalt surface; (d) removing the compaction apparatus from the backside of the note template; (d) lifting the note template clear of the asphalt surface after the compaction apparatus has moved on from the template; and (f) repeating steps (a) through (d) until a selection of the musical note templates needed to create certain melody selected for imprinting linearly along a lane of the roadway on the asphalt surface have been imprinted into the roadway, wherein grooved impressions formed in the asphalt create varying acoustic sounds representing notes of a melody as vehicle tires roll over the grooved impressions when travelling along the roadway.

In accordance with another embodiment, templates can be provided in a rectangular shape and can include an impression surface that contacts asphalt and a backside surface that can be contacted by a compaction apparatus. The impression surface can include a series of angle-iron shaped bars formed one after the other at a set distance from each other within a frame of the template. The distance between angle-iron shaped bars can correlate with a musical note for each template. The angle-iron shaped bars can create grooves within heated asphalt representing a musical note. Templates with varying distances between angle-iron shaped bars can be selectively positioned linearly one after the other to create a series of notes representing a musical melody.

In accordance with another embodiment, the asphalt can freshly rolled or reheated prior to imprinting using a rolling heating apparatus. The rolling heating apparatus can be portable, include a heat generating section supported by a wheeled housing and include means to move and navigate the apparatus over an asphalt service.

In accordance with another embodiment, an engine powered, and user piloted navigation can be included with the rolling heating apparatus. The rolling heating apparatus can also include more than one heat generating section connected linearly to preheat a longer distance of asphalt.

In accordance with another embodiment, a rolling mechanism with more than one section connected linearly can be moved and maneuverable by one person. The portable heating apparatus can include wheels and a handle to help guide a heat source over asphalt along a straight line along one side of a lane defined along the roadway and at a predefined width.

In accordance with another embodiment, an area selected for reheating can be selected at a width and location adequate for tires on one side of a vehicle to roll over the grooved impressions while remaining in the lane. For example, a pattern up to 40 inches wide and located on the right side of a lane (e.g., covering an area representing the right one-third of a lane) can enable contact with tires located on the right side of a vehicle traveling along a roadway. The pattern can obviously also be located on the left side of the lane.

In accordance with another embodiment, the ridged or simi-ridged template can be impressed into the hot or reheated bitumastic surface using compaction apparatus that can include a drum roller or other compaction apparatus such as a plate compactor.

In accordance with yet another embodiment, the imprinting method can include the further step of fine tuning the imprinted groves utilizing a hammer tool to achieve a desired groove quality, or to otherwise repair a grove. Either the manual slide hammer note tool or the manual note tool to achieve the desired quality.

In accordance with another embodiment, template can be cleaned of residue asphalt material once removed from the roadway using an angle-ironed template cleaning tool that can be craped along the angle-iron shaped bars of each template.

In accordance with another embodiment, coating either the asphalt surface or the template with a release agent can be used to minimize adherence between the asphalt surface and the template. A release agent used to coat the note template between prints may be a common industry asphalt releasing agent.

Even with the use of a release agent, the note template may have to be manually cleaned/scraped between prints, depending on the type and nature of the bitumastic (asphalt) surface that is accepting the printing process. In this case specialty tools (i.e., template cleaning tool) can be used to complete this process to ensure a clean and viable printing note templet.

In accordance with another embodiment, a ridged or simi-ridged note template can be provided that is comprised of a plurality of template rungs. Each rung can be precisely placed on each note template to achieve the correct frequency for each printed note. Lengths of cold rolled steel, common angle iron, wire rope or steel cable can be used as the rungs or runners on each note template. In the preferred embodiment, the note template can produce an interconnection of the patterns (spacing between bars formed by the rungs in a rectangular template) being imprinted on the asphalt surface. This pattern connected is achieved by means of placing the consecutive note templates first rungs into the previously printed indentation achieving the interconnection of printed notes. Each musical note on each scale will require its individual note template designed and manufactured with specific spacing that is dependent on frequency, pitch, beet, and speed limit of each specific musical road.

### BRIEF DESCRIPTION OF THE DRAWINGS

In drawings which illustrate an embodiment of the invention but should not be construed as restricting the spirit or scope of the invention in any way.

FIG. 1, labeled as prior art, is an illustration of a vehicle tire impacting a pattern of divots formed linearly along a shoulder of a roadway, also referred to as rubble strips, to alert drivers that may be veering off the road when a tire of the driver's vehicle contacts the divots;

FIG. 2, labeled as prior art, is an exemplary illustration of a vehicle veering off the roadway and passing over rubble strips formed along the outer shoulder of the roadway to alert the driver so that the driver can correct the vehicle's path;

FIG. 3 is an illustration of a vehicle passing over a pattern of divots formed as a musical melody on a side of a lane of a roadway whereon tires of the vehicle can roll over the pattern of divots to create sounds as part of a musical melody, in accordance with the embodiments;

FIGS. 4A-4C illustrate side, top and bottom views of a template that can be used to form impressions (e.g., divots) linearly into a section of a lane of a roadway that is preheated to form a musical note with the template as part of a musical melody to be formed in the roadway, in accordance with the embodiments;

FIG. 5 illustrated an alternative embodiment for a template with an exploded view illustrate the use of rope wire welded together to form a V-shaped rod that can be used to form impressions into heated asphalt;

FIG. 6 illustrates a rolling heating apparatus moving over asphalt to preheat it, in accordance with the embodiments;

FIG. 7 illustrates a rolling compacting apparatus moving over a template resting over preheated asphalt to impress the template into the preheated asphalt, in accordance with the embodiments;

FIGS. 8A-8B illustrates side and top views of a multiple section heating apparatus that can be navigated by a motorized controller over a section of asphalt to preheat it, in accordance with the embodiments;

FIGS. 9A-9B illustrate front and side views of a template cleaning tool, in accordance with an embodiment;

FIGS. 10A-10B illustrate front and side views of a groove correction tool that can be used to correct divots formed in asphalt after removal of templates, in accordance with an embodiment;

FIGS. 11A-11C illustrate front and side views of sections of an impacting groove correction tool that can be used to correct divots formed in asphalt after removal of templates, in accordance with an embodiment;

FIG. 12 illustrates a flow diagram of a method of creating impressions in a roadway representing a musical melody using templates to form divots of varying spacing, in accordance with the embodiments; and

FIG. 13 illustrated a flow diagram of another method of creating impression representing a musical melody in a roadway using templates, in accordance with the embodiments.

### DETAILED DESCRIPTION OF THE PREFERRED EMBODIMENT

This application relates to a method and apparatus for imprinting a freshly rolled or reheated asphalt surface. Asphalt is hereinafter referred to in its generic sense as meaning a paving compound for constructing roadways and the like which consists of a combination of bituminous tar and an aggregate, such as sand or gravel and asphalt emulsion binder.

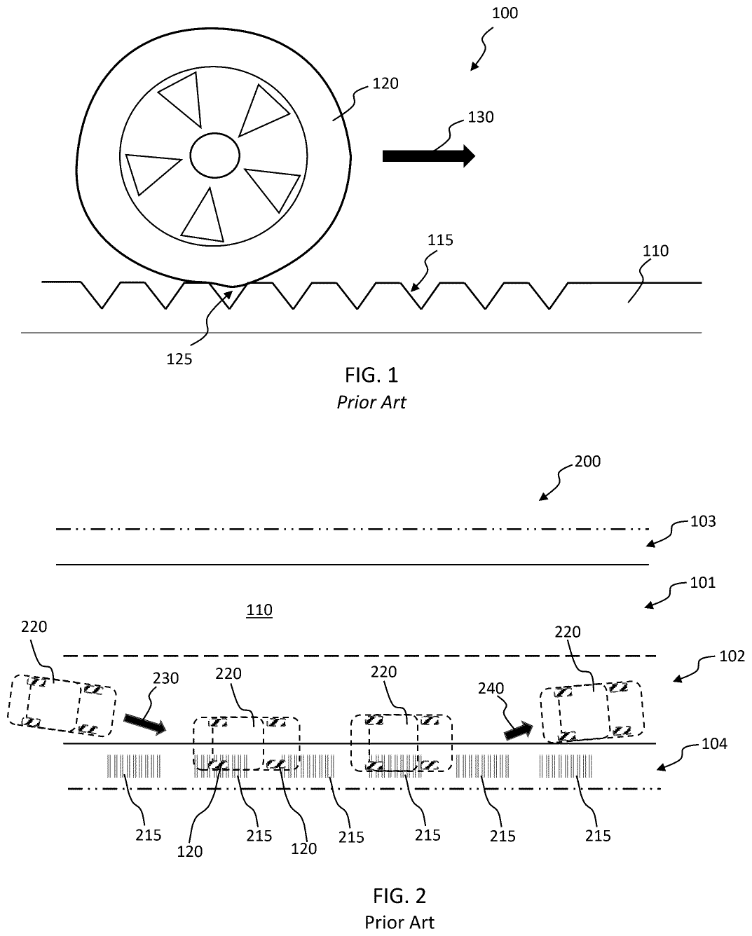

Rumble strips on the shoulders reduce run-off-the-road crashes by warning drivers they are leaving their lane. They are located just beyond the white line or the traveled portion of the roadway in the right shoulder. As of 2009, over 35 states use shoulder rumble strips on their roadways. Rumble strips alert drowsy or inattentive drivers through vibration and sound that their vehicles have left the travel lane. Referring to FIG. 1, labeled as prior art, an exemplary illustration 100 shows a tire 120 moving forward as depicted by arrow 130 along an asphalt roadway 110 that has a series of divots 115 formed into the roadway surface. As the tire 120 rolls over and impacts the pattern of divots as shown in impact location 125, a noise and vibration are created. The noise is typically of a similar “rumble” at the same tone in an on and off pattern. The noise and vibration created is based on the size of the divots and their separation from each other.

Referring to FIG. 2, also labeled as prior art, an exemplary illustration 200 is provided of a vehicle 220 veering off the roadway 110. A typical roadway 110 can include a passing lane 101, a general traffic lane 102, an inner shoulder 103 and an outer shoulder 104. Divots 115 are typically formed in a pattern of rectangular rubble strips 215 separated from each other by a short distance and formed linearly along the outer shoulder 104 of a roadway 110. As shown by arrow 230, a vehicle 220 is veering from the general traffic lane 102 of the roadway 110. As it enters the outer shoulder 104, tires 120 on the vehicle impact the rumble strips 215 causing an alternating but similar pattern of noise and vibration to alert the driver. The vehicle's direction can then be corrected by the driver as shown by arrow 240, thereby causing the vehicle 220 to get back into lane 102.

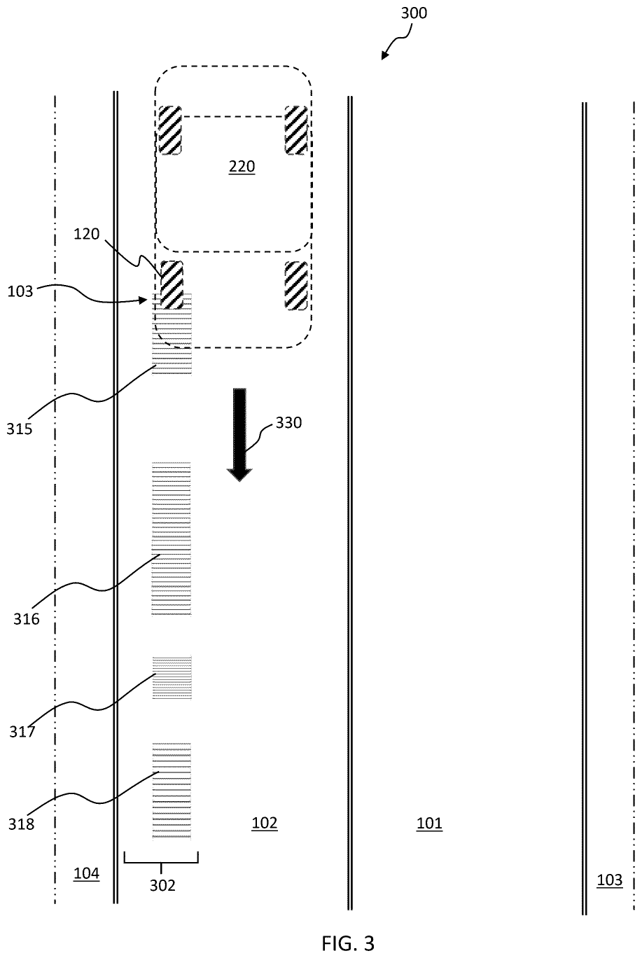

Referring to FIG. 3, in accordance with the inventive embodiments, an illustration 300 is shown of a vehicle 220 passing over a varying pattern of divots 315/316/317/318 formed as a musical melody on a side portion 302 of the general traffic lane 102 of a roadway 110. As the vehicle moves along the roadway 110 in the direction shown by arrow 330, tires 120 of the vehicle 220 can roll over the varying pattern of divots formed in the roadway 110 to create varying sounds representing notes of a musical melody. As can be seen in the example, the first rectangular pattern of divots 315 includes divots that are spaced apart more than the divots forming patterns 316 and 317. Divot pattern 317 is much shorter than the other patterns and has smaller spacing between divots formed therein. Patter 316 is the longest patter. Patterns 315 and 318 are similar. All four patterns of divots are separated from each other at varying distances. The result of the four patterns sizes, divots spacings, and spacing from each other, is varying noise (and vibration), which can represent a musical melody from the sounds emitted as tires 120 impact the varying pattern of divots formed long the roadway 110.

Although the linear layout of the divots is shown on the right side of the lane 102, it can be appreciated that they could also be placed on the left side, or even in the passing lane; however, speed can be a factor in rendering the appropriate sound of the musical melody. Speed would typically need to be controlled (e.g., 45-55 mile per hour), based on the design of the pattern representing the musical melody. Too fast of travel over the divots may not produce the proper sound and tempo for the musical melody. Furthermore, the passing lane 101 would be inappropriate and dangerous for a musical melody enhancement because speed would vary widely with passing vehicles. The width of the pattern does not have to exceed more than ⅓ of the lane at one side or the other. A rectangular template can remain up to forty inches wide and be disposed in an area of the lane that is typically traveled over by a vehicle's tires (as shown in the illustration).

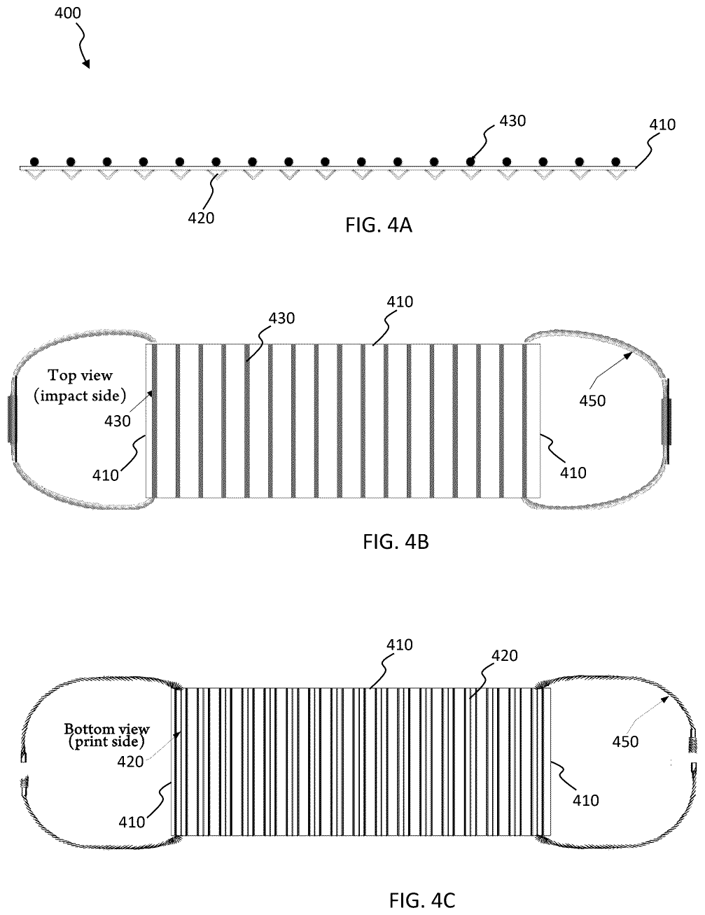

Referring to FIGS. 4A-4C, illustrated are side (4A), top (4B) and bottom (4C) views of a template 400 that can be used to form impressions (e.g., divots) linearly into a section of a lane of a roadway that is preheated to form a particular musical note with the template as part of a musical melody to be formed in the roadway, in accordance with the embodiments. The template is shown to be in rectangular in shape based on the form of a support frame 410 and can include an impression surface 420 disposed on a first (upper) side of the support frame 410 and a backside surface 430 disposed on a second (bottom) side of the support frame 410. The impression surface 420 can include a series of angle-iron shaped bars 425 formed one after the other at a set distance from each other within, and protruding from, the rectangular frame 410. The backside surface 430 can include a series of rounded bars spaced apart and adapted to allow a compaction apparatus to be moved along the backside surface. During use of the template 400 to form divots representing musical notes into a roadway, the impression surface can be moved handles 450 into place on an asphalt surface to make contact with hot asphalt and the backside surface can then be contacted by, and impacted by, a compaction apparatus. The series of angle-iron shaped bars formed one after the other at a set distance from each other within a frame that represent the impression surface 420 cause divots to be impressed into the roadway 110 as the template 400 is impacted by a compacting apparatus on its backside surface 430. The distance between angle-iron shaped bars can correlate with a musical note for each template. The angle-iron shaped bars can create grooves within heated asphalt representing a musical note. Templates with varying distances between angle-iron shaped bars can be selectively positioned linearly one after the other to create a series of notes representing a musical melody.

Asphalt can impress or compressed into (also referred to herein as “imprinted”) with a patterned template 400 constructed from a heat and pressure resistant material, such as metal. With reference to FIGS. 4A-4C, the preferred template can be a rectangular shaped grid as represented by the frame 410 and having a relatively narrow profile. The template 400 is ideally constructed to that it can be initially positioned on a freshly rolled or reheated asphalt surface 110 while it is still hot and pliable.

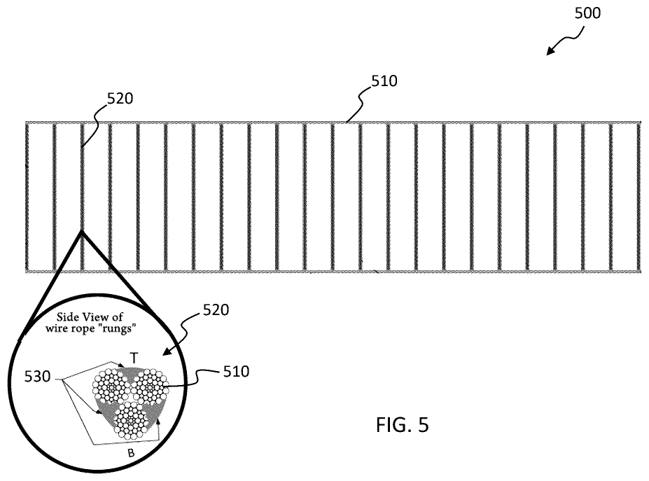

Referring to FIG. 5, illustrated is an alternative template 500 structure, in accordance with an embodiment. Template 500 can include a plurality of template modules 520, namely note templates sections, which can be loosely connected by a flexible frame 510. A flexible frame 510 can enable the template 500 to conform to the size and shape of the asphalt surface for imprinting divots representing musical notes into the roadway 110. Template 500 can be constructed from flexible rope cable that can be constructed into a desired note pattern. The template 500 can also have connected wire rope cables 450 connected to the note templet to form handles, as shown in FIGS. 4A-4C, for proper lifting and maneuvering of the impression portion of the template 500 onto a roadway 110. Also shown in FIG. 5, a blown-up illustration shows wire rope rungs 510 formed from three wire ropes welded together with metal 530 in the shape of a “V”. Each rung can be welded at its connection point to the flexible frame 510 that can also be made from wire braided steel (e.g., wire rope) by being jig welded along a seem at each junction point. Should the note templet 500 be constructed of cables this material can consist of braided steel, wire, rope, or any other suitably pliable member which will not irreversibly bend or deform when subjected to high pressure and heat. The diameter of the grid cables may vary depending upon the pattern and depth of impression desired (cables between 0.25 and 0.75 inches in diameter are suitable for most applications). As with a solid frame template, each semi-rigid note template rung spacing is unique and is based on frequency needed based on vehicle speed to produce a particular note for a musical road design. Given the flexibility of this configuration, template representing notes for each grid section can be rolled into a compact bundle for storage or transport.

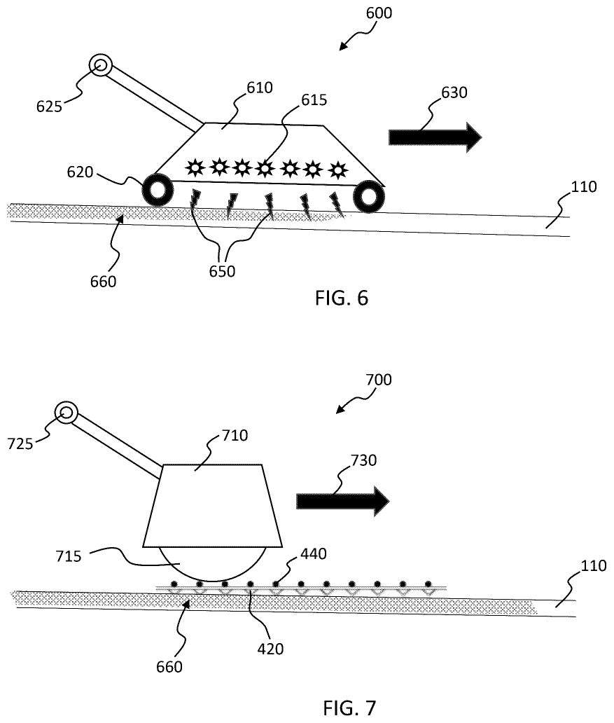

Referring to FIG. 6, illustrated is a rolling heating apparatus 600 moving over an asphalt roadway 110 to preheat it, in accordance with the embodiments. A rolling heating apparatus 600 can include a housing 610, heating elements 615 contained within the housing, wheels 620, and a handle 625. The housing can help contain and focus heat from heating elements 615 downward onto the asphalt roadway 110. The heating elements 615 can be oriented so that heat 650 is projected downward onto the asphalt roadway 110. The housing can be maneuvered by wheels 620 and the handle 625 over a specified area of the asphalt roadway that required heating. As the heating apparatus 600 is moved forward along the roadway as shown by arrow 630, asphalt become heated and malleable as shown by arrow 660. It is just after the asphalt is heated, and is now malleable, that template can be placed over the asphalt and impacted into the asphalt to form divots.

Referring to FIG. 7, illustrated is a rolling compacting apparatus 700 shown by arrow 730 to be moving over a template 400/500 resting over preheated asphalt roadway 110. The rolling compacting apparatus can be used to impress the template into the preheated asphalt, in accordance with the embodiments. Templates with varying grid patterns representing various musical notes can be progressively compressed into an asphalt surface 110 by using a compacting apparatus 700 such as by using a double drum roller, a vibrating plate tamper, or some other surface compactor. Following the compression step, template 400/500 can be manually lifted clear of asphalt surface and then the stamped asphalt is allowed to cool and harden. In this manner, ordinary asphalt may be imprinted in such a manner that said imprints can create varying frequencies that produces musical notes along a roadway as discussed in FIG. 3. Notes represented in each template can be arranged to produce a musical melody in the imprinted asphalt.

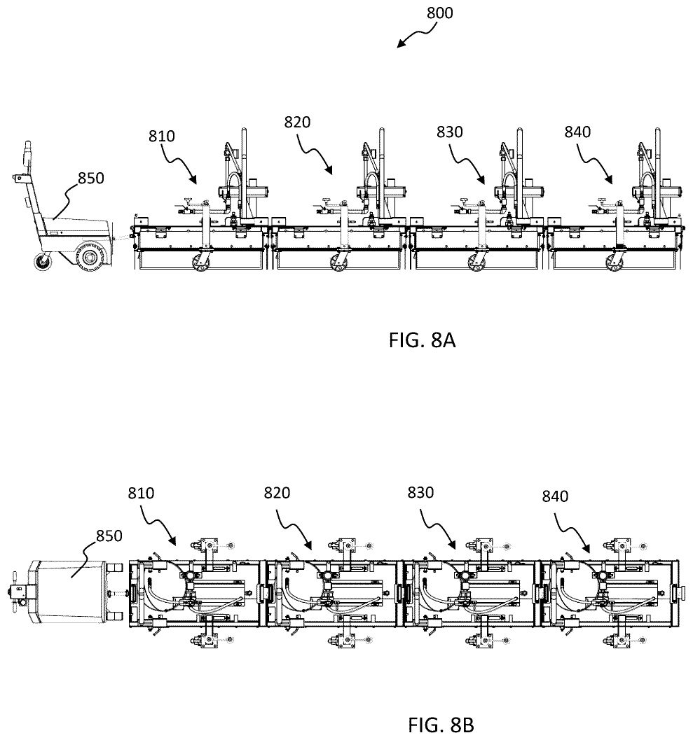

Referring to FIGS. 8A-8B illustrates side and top views of a multiple section heating apparatus 800 that can be navigated by a motorized controller 850 over a section of asphalt (as shown in FIGS. 3 and 6) to preheat it, in accordance with the embodiments. A multiple section heating apparatus can include a chain of connected heating units 810-840 and a motorized controller 850. Multiple heating elements contained in a chain of heating units can assure that an asphalt surface is properly heated to accept templates 400/500. The multiple section heating apparatus 800 can be designed to create a heated section of asphalt along a roadway that is set to a particular width (e.g., up to 40 inches wide for a musical roadway). The motorized controller can be human controlled, it can be remote controlled, or can include components (e.g., computer, imaging, programming) to provide for autonomous navigation of the system along a prescribed path, such as a leaner path along a section of roadway.

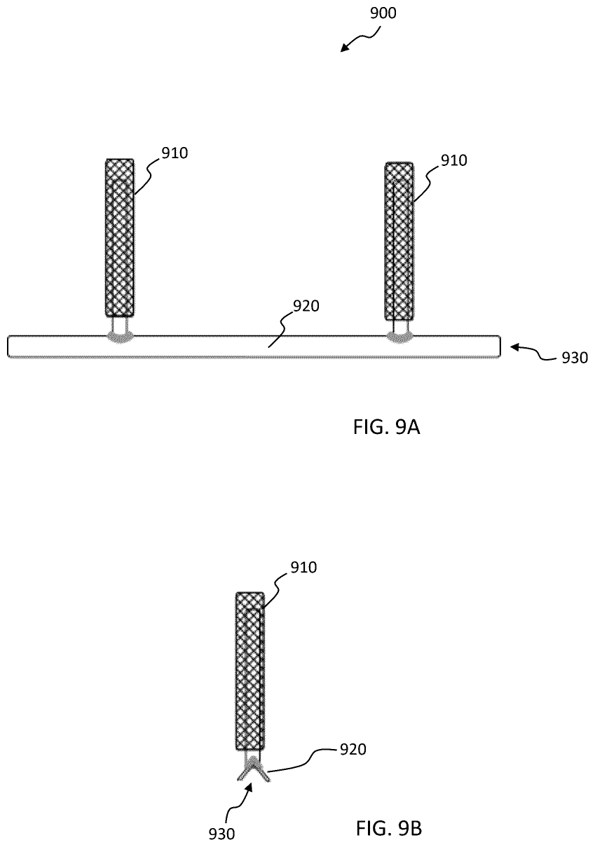

Referring to FIGS. 9A-9B, illustrate are front and side views of a template cleaning tool 900, in accordance with an embodiment. A template cleaning tool 900 can include at least one handle 910 and a frame forming an inverse “V” 930 that is complimentary to the “V” sections of the template 400/500. The impression surface of a template can be cleaned using the template cleaning tool 900 to scrape “V” shaped sections that make contact with asphalt, in order to remove any asphalt remaining on the template.

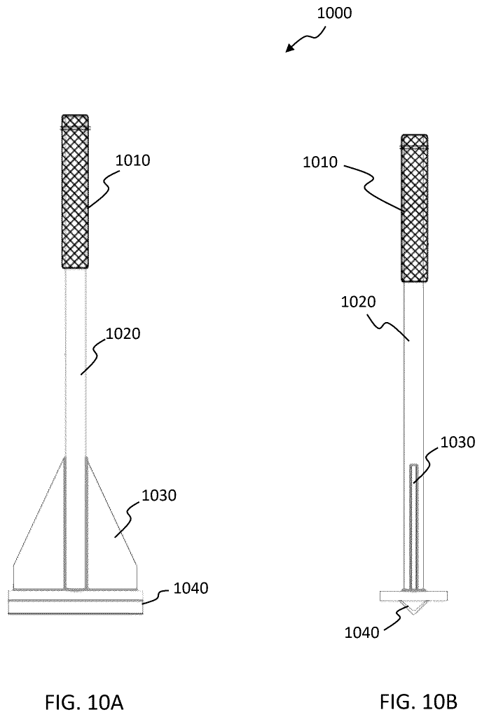

Referring to FIGS. 10A-10B, illustrated are front and side views of a groove correction tool 1000 that can be used to correct divots formed in asphalt after removal of templates 400/500, in accordance with an embodiment. Divots formed in asphalt can sometimes require correction or repair after removal of a template. The groove correction tool 1000 can allow a worker to make divot corrections. The groove correction tool can include a handle 1010, a shaft 1020 and an angled correction surface 1040 that matches the V-shaped sections of a template used to create divots into heated asphalt. Supports 1030 can also be included to attach the shaft 1020 to the angled correction surface 1040. Supports 1030 can also function as heat sinks to help absorb and deflect heat taken on by the angled correction surface 1040 during us on hot asphalt.

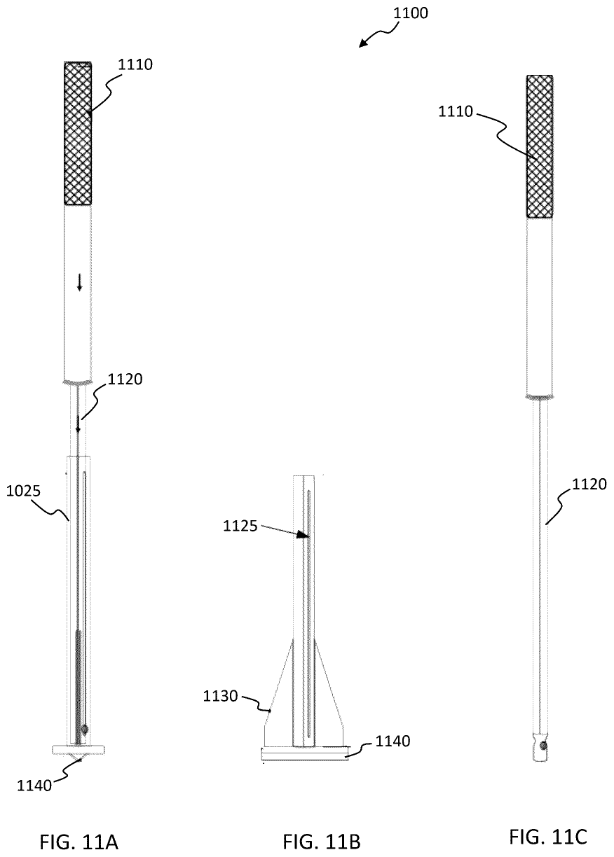

Referring to FIGS. 11A-11C, illustrated are front and side views of sections of an impacting groove correction tool 1100 that can also be used to correct divots formed in asphalt after removal of templates 400/500, in accordance with an embodiment. The impacting groove correction tool 1100 can include a handle 1110, a shaft 1120, an impact receiver 1125, an angled correction surface 1140, and support 1130. Impacting force from the impacting groove correction tool can be created by manipulating the handle 1110 and shaft 1120 up and down to cause the shaft 1120 to repeatedly collide with the impact receiver 1125 causing the angled correction surface 1140 to manipulate asphalt during the divot correction process. Gravel is often used in asphalt and can require some impact to cause gravel to be immersed into the surface of the divot.

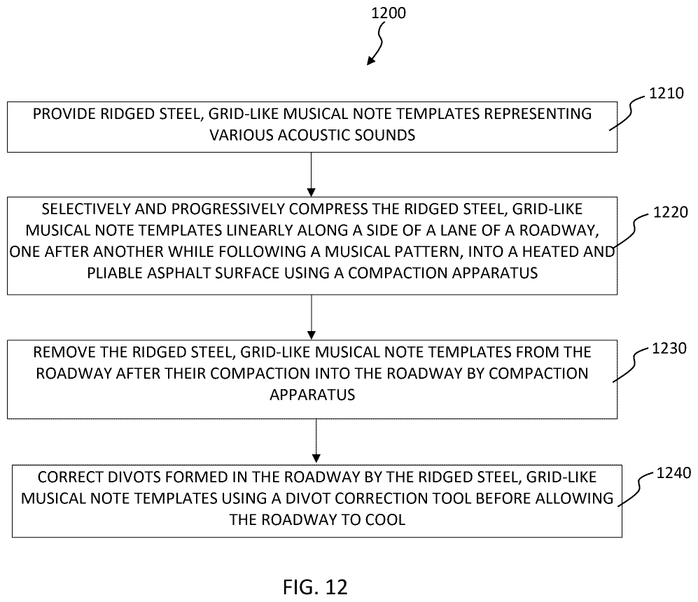

Referring to FIG. 12, illustrated is a flow diagram 1200 of a method for creating impressions in a roadway representing a musical melody using templates to form divots of varying spacing, in accordance with the embodiments. As shown in Block 1210, ridged steel, grid-like musical note template representing various acoustic sounds are provided. As shown in Block 1220, Ridged steel, grid-like musical note template are selectively and progressively compressed linearly along a side of a lane of a roadway, one after another while following a musical patter, into a heated and pliable asphalt surface using a compaction apparatus. The ridged steel, grid-like musical note template are removed from the roadway after their compaction into the roadway by the compaction apparatus, as shown in Block 1230. Them, as shown in Block 1240, divots formed in the roadway by the steel, grid-like musical note templates are corrected using a divot correction tool before allowing the roadway to cool.

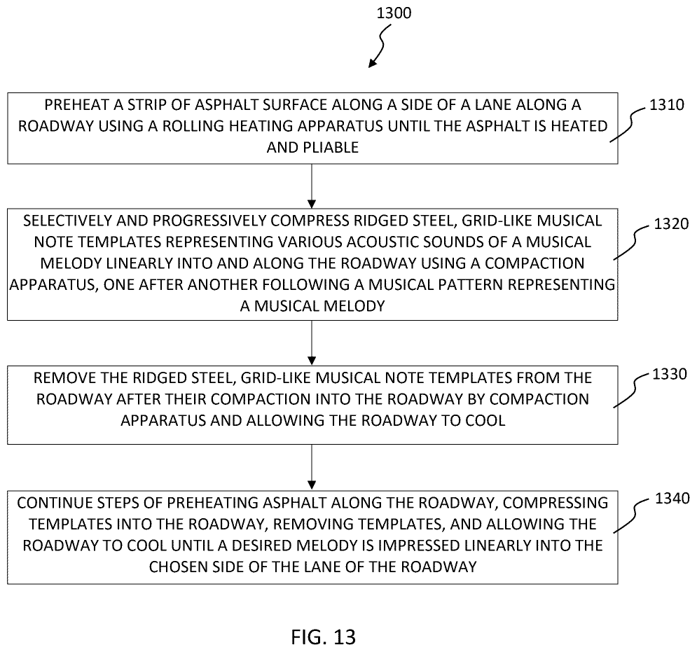

Referring to FIG. 13, illustrated is another flow diagram 1300 of another method of creating impression representing a musical melody in a roadway using templates, in accordance with the embodiments. Referring to Block 1310, a strip of asphalt surface is preheated along a side of a lane along a roadway using a rolling heating apparatus until the asphalt is heated and pliable. Referring to Block 1320, ridged steel, grid-like musical note templates representing various acoustic sounds of a musical melody are selectively and progressively compressed linearly into and along the heated and pliable asphalt surface of the roadway using a compaction apparatus, one after another following a musical pattern representing a musical melody. The ridged steel, grid-like musical note templates are then removed from the roadway after their compaction into the roadway by compaction apparatus and the roadway is allowed to cool, as shown in Block 1330. Then, as shown in Block 1340, steps of preheating asphalt along the roadway, compressing templates into the roadway, removing templates, and allowing the roadway to cool are repeated until a desired melody is impressed linearly into the chosen side of the lane of the roadway.

In operation, note template 400/500 can be assembled from various grid sections as described above and can be positioned on a hot asphalt surface after it is initially rolled and smoothed. At such time, asphalt surfaces can be very hot (typically on the order of 275 degrees to 300 degrees Fahrenheit) and can be in a plastic or semi-plastic state. Accordingly, note templates can be coated with a petroleum-based release agent to minimize adherence between template rungs and, or templet cables, and the hot asphalt surface of a roadway. This can facilitate removal of note template 400/500 after it has been compressed into asphalt surface 110 as shown in FIG. 7.

When heating an asphalt surface, heat can be gradually applied to the asphalt surface in such a manner as to avoid scorching of that asphalt surface to eventually heat at a minimum of 2″ and not more than 3″. In one embodiment the method a portable heating apparatus can be provided having infrared heaters mounted for reciprocal movement in a travel path periodically passing over the marking and the underlying substrate. The heating method can permit direct visual monitoring of the work site to achieve optimum adhesion of the marking to the asphalt or other substrate.

After reheating of the asphalt has taken place and prior to imprinting a musical note with template 400/500, legends and symbols can be placed in area to be printed onto the roadway surface near the impressed divots as guide marks or legends for the musical roadway. Material for legends and symbols may be manufactured out of preformed marking tape, paints, or preformed thermoplastic standard materials. Various other acrylic, epoxy, or latex-based protective coatings may be applied to asphalt surface after the impression step to seal the imprinted asphalt surface and enhance the location of the musical roadway imprint.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A method of imprinting an asphalt surface comprising:
selectively and progressively compressing ridged steel, grid-like musical note templates representing various acoustic sounds of a melody linearly along the roadway, one after another, into the heated and pliable asphalt surface using a compaction apparatus;
removing the ridged steel, grid-like musical note templates from the roadway after their compaction into the roadway by compaction apparatus and allowing the roadway to cool; and
repeating steps of preheating asphalt along the roadway, compressing template into the roadway, removing templates, and allowing the roadway to cool until a desired musical melody is impressed linearly into the chosen side of the lane of the roadway.

2. The method of claim 1, further comprising the step of preheating a strip of asphalt surface along a side of a lane along a roadway using a rolling heating apparatus until the asphalt is heated and pliable prior to selectively and progressively compressing ridged steel, grid-like musical notes template linearly along the roadway.

3. The method of claim 1, wherein said step of selectively and progressively compressing ridged steel, grid-like musical note templates representing various acoustic sounds of a melody linearly along the roadway, one after another, into the heated and pliable asphalt surface using a compaction apparatus is carried out on an asphalt surface immediately after said asphalt surface is initially rolled for a roadway.

4. The imprinting method of claim 1, further comprising the step of coating at least one of said asphalt surface or said compressing ridged steel, grid-like musical note templates with a release agent to minimize adherence between said asphalt surface and said compressing ridged steel, grid-like musical note templates.

5. The imprinting method of claim 1, wherein said ridged steel, grid-like musical note templates each comprise an open framework specifically designed to produce a certain frequency.

6. The imprinting method of claim 1, wherein said note templates are lengths of ridged or semi-rigid steel plates, angle iron, cold rolled steel, wire rope or cable of substantially constant diameter.

7. A method of creating a musical road, comprising:
providing ridged steel, grid-like musical note template representing various acoustic sounds;
selectively and progressively compress the ridged steel, grid-like musical note templates linearly along a side of a lane of a roadway, one after another while following a musical pattern, into a heated and pliable asphalt surface using a compaction apparatus;
remove the ridged steel, grid-like musical note templates from the roadway after their compaction into the roadway by compaction apparatus; and
correct divots formed in the roadway by V-shaped sections of the ridged steel, grid-like musical note templates used to form the divots using a divot correction tool before allowing the roadway to cool.

8. The method of claim 7, wherein divots are corrected using a divot correction tool, wherein the divot correction tool includes a handle, a shaft and an angled correction surface that matches V-shaped sections of the ridged steel, grid-like musical note templates used to create divots into heated asphalt.

9. The method of claim 8, wherein the divot correction tool further includes an impact receiver adapted to receive impacting force from the shaft of the divot correction tool created by up and down motion to cause the shaft to repeatedly collide with the impact receiver causing the angled correction surface to manipulate asphalt within the divot.

10. The method of claim 7, further comprising the step of providing legends and symbols on the roadway surface near the impressed divots as guide marks or legends for the musical roadway, and coating the musical roadway to seal divots formed on the asphalt surface and enhance the location of the musical roadway.

11. A method of imprinting an asphalt surface with a musical melody, comprising:
(a) providing a pliable note template comprising one or more releasably connectable template modules for impressing a predefined pattern in said asphalt surface;
(b) positioning said template on said asphalt surface;
(c) compressing said note template into said asphalt surface using a compaction apparatus separate from said template to leave an impression of said predefined pattern in said asphalt surface;
(d) removing said compaction apparatus from said template; and
(e) lifting said template clear of said asphalt surface.

12. The imprinting method of claim 11, wherein said note template is impressed into said asphalt surface immediately after said asphalt surface is initially rolled.

13. The imprinting method of claim 11, further comprising the step of coating one of said asphalt surface or said note template with a release agent to minimize adherence between said asphalt surface and said template.

14. The imprinting method of claim 11, wherein said compaction apparatus is at least one of a drum roller or plate compactor.

15. The imprinting method of claim 11, wherein said one or more note releasably connectable template modules each comprise an open framework specifically designed to produce a certain frequency.

16. The imprinting method of claim 11, wherein said note templates are lengths of ridged or semi-rigid steel plates, angle iron, cold rolled steel, wire rope or cable of substantially constant diameter.

17. The method of claim 12, wherein said note template include V-shaped sections that are integrally connected in substantially parallel relation by a length of a frame, said V-shaped sections representing rungs extending therebetween within the frame.

18. The method of claim 17, wherein said rungs are between 0.25 and 0.75 inches in diameter, width and height.

19. The method of claim 17, wherein said rungs have a substantially constant dimension.

20. The method of claim 16, wherein said V-shaped section are lengths of three-wire sections welded together to form a shape of a V.
